(19) United States
(12) Patent Application Publication
(10) Pub. No.: US 2020/0034923 A1
(43) Pub. Date: Jan. 30, 2020

(54) Application and website that facilitates Cash Loans

(71) Applicant: John Martin, Kearns, UT (US)

(72) Inventor: John Martin, Kearns, UT (US)

(21) Appl. No.: 16/047,021

(22) Filed: Jul. 27, 2018

(51) Int. Cl. G06Q 40/02; G06F 17/30; G06F 9/54; G06F 9/451

(52) U.S. Cl. CPC G06Q 40/025; G06F 9/451; G06F 9/54; G06F 17/30244

(57) ABSTRACT

This disclosure relates generally to computer-implemented data processing system operated through a software application, which comprises a database, an offering module comprising an offering user interface for a borrower to upload pictures of an item as collateral into the database. An evaluation system allowing the lenders on the panel list to give their loan offer to the borrower. The application would facilitate the pawnshops and title lenders to input their pre-approved estimate of the loan amount and provide the Annual Percentage Rate (APR). The customer would be able to receive loan offers based on the appraised value estimate of their uploaded items by multiple lenders in that particular area. The app would also indicate the distance of each broker from customer's location. The whole process will facilitate the customer to make the decision based on loan amount, APR and distance of the lender from their location such as their home or workplace.

### BACKGROUND

### Field of the Invention

The invention relates to an online website and app that refers customers to pawnshops and title loan centers that use a commodity of value for a loan. The current invention is based on automating the where the valuation of the collateral is done prior to the actual physical transaction by allowing the lender to review and appraise the collateral with an online app and determine an estimated loan offer amount (pre-approval), APR, and store location to the customer. With that information, the customer knows where to complete the business transaction.

As for the Pay day and signature lenders, the system allows the customer to apply for loans based on their credit and verification of income. Customers review and select the best loan for them based on the loan amount, APR or distance from the lenders. This also helps the businesses in their community and supports their local economy.

### Description of the Related Art

The principle is applicable in participating pawnshops and title loan centers since banks and financial institutions do not work with subprime loans. Customers with little or no credit go to pawnshops or title lenders and use their collateral for a loan.

Pawnshops and title lenders make loans based on the value of the collateral. A pawn is another term for a collateral loan. Pawnshops lenders lend money on items of value ranging from gold and diamond jewelry, musical instruments, televisions, electronics, tools, household items, firearms, and more and title loans are backed by vehicles, boats, motorcycles and other items with a title. Loans are based on the value of the collateral and many of their loans average between 50 to 60 percent loan to value.

Using the services of conventional pawnshops or title lenders usually brings about the inconvenience to the customer that he has to bring or send the item to the pawnshops or title lender before they decide to make an offer on the item. Moreover, having brought the item for inspection, they usually make only one offer which the customer may accept or not. The other lenders may be at a distance and a huge physical effort is normally required and still, a comparative rate may not be acquired.

The current invention is based on the computer and mobile-based software application, which will have a number of cash loan centers of a certain area with online access. For the pawnshops and title lenders, the borrower would upload the photo of their collateral and store employee would evaluate the item to issue a pre-approved loan offer. This invention will not only connect the borrowers at their location to their local lenders but would speed up the process of attaining a loan. The invention would also facilitate the borrower to choose the lender with the best loan terms and the lender will get an opportunity to increase their business coverage area. The previous embodiments in the field did not provide such facilitation and hence the idea has its own novelty.

### SUMMARY

The invention is a software app and a website accessible through mobile and computing devices that allows potential borrowers to connect to nearest cash lenders. The customers would be able to upload photos of different tangible collateral products to back loans from local pawn and title lenders. Different local pawnshops or title lenders would review the photos of the uploaded item and appraise them in monetary value. The application would facilitate the pawnshops and title lenders to input their pre-approved estimate of the loan amount and provide the Annual Percentage Rate (APR)) and loan terms. The customer would be able to receive the pre-evaluation of their uploaded items along with the APR and loan terms from and loan terms by from multiple lenders in their particular area. The app would also indicate the distance of each lender from customer's location. The whole process will facilitate the customer to make the decision based on loan amount, APR and distance of the lender from customer's location.

The customer would make the decision and confirm with the participating lender through the application. In response, both parties would meet at the store or by delivery for a fee if available. The final approval of the loan will take place once each item's condition is reviewed in person by the store employee. The final value of the collateral product may vary in some cases.

Pawnshops and title lenders offer loans to people with personal property used as collateral. Pawning an item for a loan implies that the customer who is a borrower delivers the item to the pawnshop. Within a certain period of time, the borrower may purchase the item back with interest. If the loan is not paid back within the time period or, if applicable, the time period is not extended, the pawned item will be offered for sale by the pawnshop. The lender may, for example, auction off the pawned item after the time period expires.

Lenders issue pre-approved loan offers and customers choose the best loan based on the loan amount, APR, or store location. Customer drives to the selected loan centere with the collateral or participating lenders may drive to the customer's address to complete the transaction and pick up the collateral for an additional mileage fee.

In addition to pawnshops the invention and system would also facilitate signature loans and payday loans that are also in the cash lending industry but do not need collateral since they are based on their personal credit history and income verification. The application would connect customers to these types of lenders near their area. All the compliance, documentation, and cash disbursement would be done by a store employee. This system simply connects customers to the lender of their choice so they can finish the transaction at the store (or by delivery). The system charges a small service fee to the lender for the customer referral made through the application.

While a specific embodiment has been shown and described, many variations are possible. With time, additional features may be employed. The various configuration may be changed to suit the system or equipment with which it is used.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The system for lending small loans also known as pawn loan has not changed drastically over a couple of centuries. Today customers still have to walk or drive down to their local lender and show them their collateral they wish to pledge for a loan. These pawnshops and title lenders offer short-term loans against the valuation of the product. The borrower is normally offered 50 to 60% of the item's appraisal. The APR for such loans is normally on the higher side when compared to loans offered through financial institutes. If a customer defaults on the loan the lender normally sells or auctions the item at a markup to cover the loan amount and interest. All legal and compliance documentation is done at the local store with mutual consent of the borrower.

The local cash lending industry is still mostly using the traditional methods of advertisement but are not using the online forum for marketing and business processes. In case if the online forum is used, its scope is very limited and still, the public at large is not aware of it.

The current invention which is a software application accessible through the computer, mobile and other computing devices would introduce an online portal for small loan evaluations and transactions. The concept is based on grouping a number of cash loan lenders online through the web and software app. The customers interested in a collateral loan would not need to visit multiple stores anymore. The customer would be able to upload photos and a description of the item they want to put as collateral and the local pawnshops and or title lenders make their appraisal and pre-approved loan offer.

The offers would be sent to the customer in comparative form. The offer would include estimated appraisal, pre-approved loan amount, APR, loan terms and store distance to the customer. This will help the customer choose the lender by comparing and choosing the best term for them through the application. The application would also facilitate the meeting point and time for both parties, which is usually at the store and some participating lenders may be able to drive to the customer for an additional mileage fee. This allows the customer to choose the right lender in light of the loan term offers given by multiple lenders after the evaluation.

The application would not be limited to collateral lending but also the signature and payday loans as well. The customer would be able to submit loan applications based on their personal credit and employment information to set of authorized lenders through the app. The customer would be able to choose the lenders from the list given in the app. In return, the local lenders would offer their terms, rates and pre-approved amount of loan. The customer will select the best loan for them and receive instructions from the app to either finalize the documentation at the store or by delivery for a mileage fee, if available.

In this particular invention one aspect is the provision of securing the transaction and evaluating the collateral through the app or website. An embodiment of the present invention provides a computer-implemented data processing system which comprises: a database, an offering module and user interface for both parties to enter their details and upload an item as collateral into the database. The same system would have a module comprising a user interface for pawnshops and title loan centers to review customer loan requests based on various types of collateral offered. The customer can review and compare local offers.

In the following, a customer who is interested in borrowing money and who uploads an item of personal property as collateral will be called borrower or customer. This term may refer to a private person, a company or other type of organization. The party or brokers offering the loan would be called the lenders.

The above system allows the borrower to find local pawnshops or title lenders by submitting an online loan request and uploading its pictures and description so other lenders in the area can review and respond with multiple offers. Using the offering user interface, the borrower may enter further details into the system like an item description, a minimum price, etc., as set forth in detail below. The loan requests in the database are available to all interested lenders in the area and would give their evaluation, pre-approved loan figure and any conditions if applicable.

In a preferred embodiment, the system has an expiration on loan requests and offers.

This allows to close the evaluation of the item at a predetermined time. Including a time encourage a response sooner, faster loans and better terms for the customer.

Some parameters of the system and method according to the present invention may be individually predetermined by the borrower or by the lender. In a preferred embodiment, the system further connects the customer to the nearest store or their choice to complete the loan transaction.

According to a preferred embodiment, the system further comprises of a delivery user interface that allows the lender to pick up and hold the item for collateral and hand cash under the loan terms.

Customers would be able to benefit through the invention because they can compare and choose the loan offers before leaving their place. This adds convenience, saves time and energy driving to multiple lenders as the customers would derive only to the lender they choose based on the pre-approved loan.

The lenders would also be the beneficiaries through the app as the application would ensure that more customers can reach them. It would be a source of marketing the area dynamics for the lenders would increase as far end customers would also be able to reach them through the website or application. Many customers may be willing to drive further away to a store with a better offer extending the store's horizon in reaching more customers.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

1. A computer-implemented data processing system enabled through a software app comprising a database, multiple modules comprising of a user interface for borrowers and lenders. The system of claim 1, further comprising a timer to determine if a predetermined time has elapsed since the items and pictures were entered into the database The system of claim 1, further comprising a timer to determine if at least one evaluation or more were confirmed by the lenders for the uploaded items. A computer-implemented method comprising: receiving and storing the pictures and loan application from the customer for the appraisal and loan evaluation. having a team of lenders on the panel to review and evaluate the items allowing the customers to choose from multiple lenders according to the loan term such as APR and loan amount. notification to both parties on confirmation of the selection of the borrower. Delivery if required at the door step of the customer for a mileage fee. Appraisal of the collateral item prior to physical inspection.
